(19) United States
(12) Patent Application Publication
(10) Pub. No.: US 2023/0139834 A1
(43) Pub. Date: May 4, 2023

(54) ASYNCHRONOUS NETWORK INVENTORY SYSTEM

(71) Applicant: AT&T Intellectual Property I, L.P., Atlanta, GA (US)

(72) Inventors: Farhad Noori, Alpharetta, GA (US); Chandra Cinthala, Suwanee, GA (US); Vikas Varma, Marietta, GA (US)

(73) Assignee: AT&T Intellectual Property I, L.P., Atlanta, GA (US)

(21) Appl. No.: 17/515,991

(22) Filed: Nov. 1, 2021

(51) Int. Cl. H04L 29/06; H04L 12/26

(52) U.S. Cl. CPC H04L 65/601; H04L 43/045; H04L 43/0817; H04L 65/608

(57) ABSTRACT

The asynchronous network inventory system provides real time and asynchronous capabilities for network applications to interact with the database of record.

### BACKGROUND

OSS/BSS, in telecommunications, refer to operations support system (OSS) and business support system (BSS). The distinction emphasizes a separation of concerns between maintaining network operations and the business around which that network is built. Communications service providers support a broad range of services and functions with their OSS/BSS. BSS primarily consists of order capture, Customer Relationship Management and Telecommunications billing whereas OSS covers Order Management, Network Inventory Management and Network Operations.

This background information is provided to reveal information believed by the applicant to be of possible relevance. No admission is necessarily intended, nor should be construed, that any of the preceding information constitutes prior art.

### SUMMARY

Conventionally network operators do not have streaming capabilities to load inventory or utilize network elements at scale. The disclosed asynchronous network inventory system provides real time and asynchronous capabilities for network applications to interact with the database of record. It also provides an automatic mechanism to build the network topology for services that inventory the physical, compute and virtual network elements. In an example, a vehicle may include a processor and a memory coupled with the processor that effectuates operations. The operations may include configuring the plurality of streaming functions to connect with a plurality of external system functions; connecting the streaming engine with the plurality of external system functions; and executing services using the streaming engine, wherein the multiple external system functions operate asynchronously with the streaming engine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary network system in the OSS.

FIG. 2 illustrates an exemplary asynchronous network system in the OSS.

FIG. 3 illustrates an exemplary asynchronous network system method.

FIG. 4 illustrates a schematic of an exemplary network device.

FIG. 5 illustrates an exemplary communication system that provides wireless telecommunication services over wireless communication networks.

### DETAILED DESCRIPTION

Data integrity and performance are factors in the success of any inventory system that provides producers and consumers a homogenous data repository platform. Today’s telecommunications software ecosystems that enable functions, such as network and service provisioning, service instantiation, and network element deployment, often require applications to follow a rigid process (e.g., synchronously go from one application or function to another) to build network function nodes and relative topology in sequence. This is prone to errors across impacted applications including latency issues, gaps in data, etc.

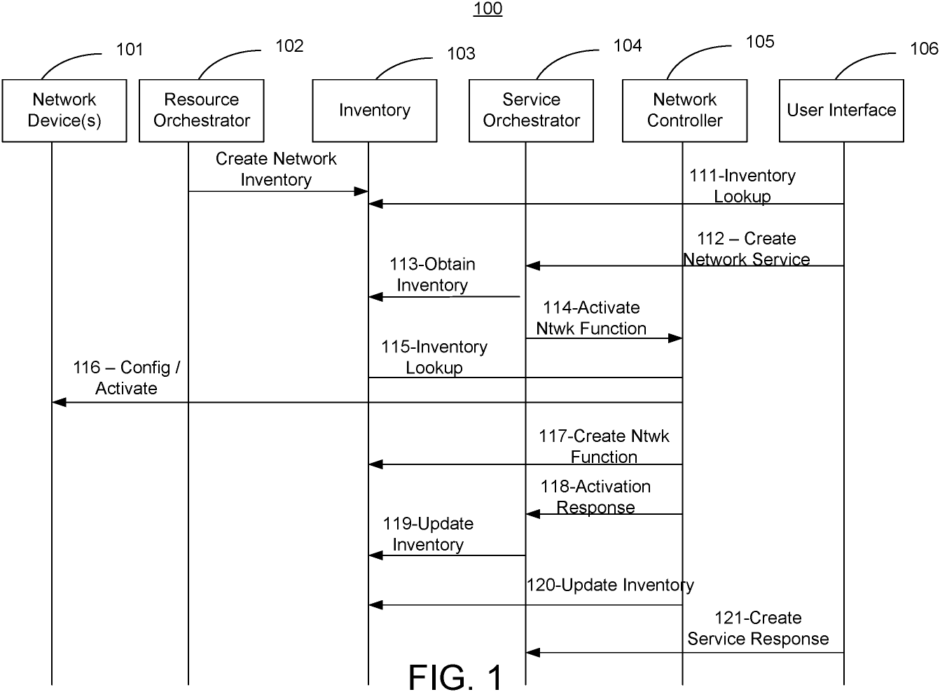

FIG. 1 illustrates an exemplary network system in the OSS. System 100 may include network device 101, resource orchestrator 102, inventory 103 (e.g., a repository of data), service orchestrator 104, network controller 105, and user interface 106, which may be communicatively connected with each other. Resource orchestrator 103 may provide instructions to create inventory 103 in the network inventory system. Inventory 103 persists the network inventory (e.g., the database is up-to-date even if there’s a disconnect because it creates/updates data in parallel). At step 111, inventory 103 may receive a message to look up network inventory for display on user interface 106. At step 112, a create network service request may be initiated and sent to service orchestrator 104, which may be based on input from user interface 106. At step 113, based on the request of step 112, inventory 103 receives, from service orchestrator 104, look up for inventory. At step 114, service orchestrator 104 sends a message to activate network service to network controller 105. At step 115, inventory 103 may receive a look up of inventory from network controller 105. At step 116, based on the inventory lookup of step 115, network controller 105 sends instructions to configure network device 101. At step 117, based on the configuring of step 116, network controller sends instructions to create the network function inventory in inventory 103. At step 118, in response to the activate network service request, network controller sends a response to service orchestrator 104. At step 119, inventory 103 may receive instructions, from service orchestrator 104, to update a network function inventory or service inventory (e.g., status updates). At step 120, inventory 103 receives instructions, from network controller 105, update a network function inventory or service inventory (e.g., status updates). At step 121, service orchestrator 104 sends response to the create network service request of step 112 to user interface 106.

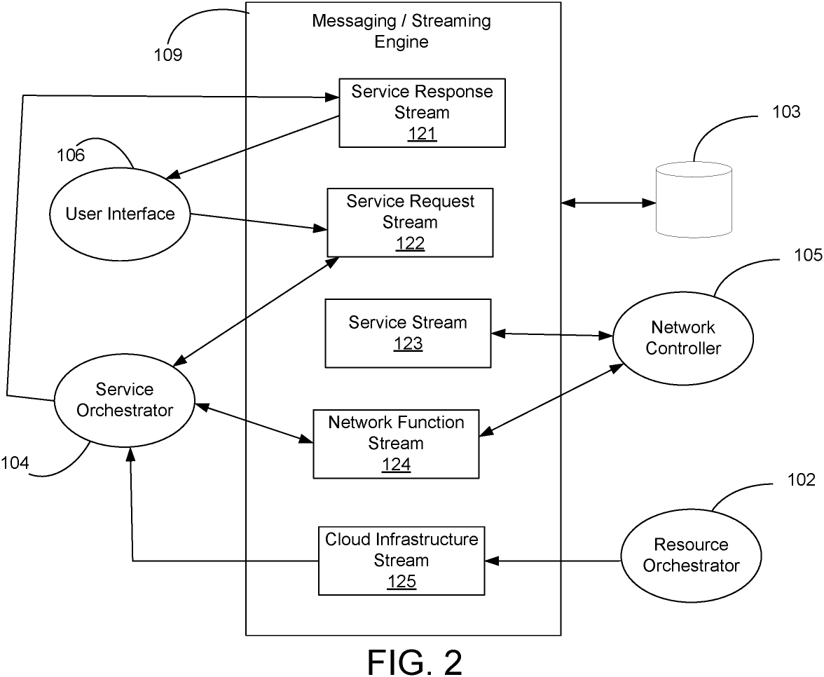

FIG. 2 illustrates an exemplary asynchronous network system in the OSS. The disclosed asynchronous network systems may operate asynchronously and in parallel, therefore many of the applications/functions are not necessarily dependent on one another. Processes may happen as events are loaded into messaging/streaming engine 109. Messaging/streaming engine 109 may include service response stream 121, service request stream 122, service stream 123, network function stream 124, or cloud infrastructure stream 125. There may be sequences of event messages with time stamps. A change will create an event that flow in order in the streaming engine, but will have different types of messages for different consumers (e.g., provisioning, changed statuses, updated services, etc.). The applications in the network systems are loosely coupled and messages/events are pulled/pushed asynchronously.

The disclosed asynchronous network systems concept is async and in parallel, applications may not be necessarily dependent on another, and processes may happen as events are loaded into the messaging/stream engine. The applications in the network systems are loosely coupled and messages/events are pulled/pushed asynchronously. In addition, while the conventional approach performs blocking the disclosed approach may be non-blocking and therefore may more efficiently utilize resources. For example, resource Orchestrator creates/pushes the cloud infrastructure asynchronously. User Interface shall create the service request asynchronously. Service Orchestrator pulls the requests asynchronously. Network controller performs the activation and configuration of network service/functions asynchronously. The streams are archived/persisted in an inventory database for analytics/reporting and the display on a user-interface. With the disclosed subject matter, the operations are asynchronous. Each application may run it parallel, and all the responses may be consolidated asynchronously.

With reference to FIG. 2, for streams / functions, the definition/description below may provide connections in the flow of the proposed application. Service response stream 121 is an event stream that may include all responses to a service request. Service request stream 122 may be an event stream that includes all network service creation requests. Service stream 123 may include all events related to a network service. Network function stream 124 may include all events related to a network function. Cloud infrastructure stream 125 may include all events related to region/tenant/compute/VM/interfaces/Subnets/IP/Addresses. Resource orchestrator 102 may include acts as the provisioning coordinator between requesting network functions, inventory, or provisioning applications. Inventory 103 may be the repository of all relative physical/virtual network elements/network functions, or their relationships. Service orchestrator 104 may be an application that acts as the service coordinator/manager for the workflow between requesting service functions, inventory, or provisioning applications. Network controller 105 may an application that provides/configures physical/logical network functions for the provisioning service. User interface 106 may be the graphics / dashboard that the user actually interacts with to execute / inquire about the network function / topology.

The disclosed system may use a Smart Data Movement as a Platform (DMaaP) system and leverage a Kafka platform. Kafka is a framework implementation of a software bus using stream-processing. It is an open-source software platform. The smart DMaaP may act as a reactivator to provide asynchronous service to its clients with simple operations utilizing DMaaP topics to load or get data to/from its staging or the underlying database (event-driven network inventory services). Reactivator implies reactivate systems that are stubbornly responsive due to elasticity and resilience features, in which the features may come from the Kafka platform. The disclosed asynchronous network system may include functionalities, such as1) DMaaP topic to provide simple transaction endpoints; 2) asynchronous operation to provide seamless transactions; 3) smart microservice to construct data stack then load into database; or 4) front door for consumers to get validated data.

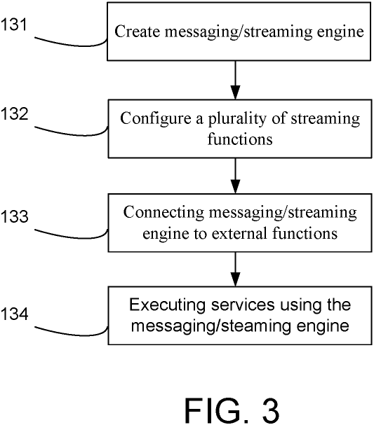

FIG. 3 illustrates an exemplary method for an asynchronous network system. FIG. 1 shows synchronous connections between interfaces, hence hard dependencies from one application to another. FIG. 2 is showing asynchronous connection where applications are only connected to event streams, not to each other. As the events occur, the required updates are distributed to the subscribers of the events. At step 131, creating a messaging/streaming engine 109 for OSS that includes a plurality of streaming functions. The streaming functions may include service response stream 121, service request stream 122, service stream 123, network function stream 124, or cloud infrastructure stream 125.

At step 132, configuring the plurality of streaming functions to connect with a plurality of external system functions. The external system functions may include user interface 106, service orchestrator 104, inventory 103, network controller 105, or resource orchestrator 102. Messaging/streaming engine 109 may configure connections with user interface 106 to service response stream 121 or service request stream 122. Messaging/streaming engine 109 may configure connections with service orchestrator 104 to service response stream 121, service request stream 122, service stream 123, network function 124, or cloud infrastructure stream 125. Messaging/streaming engine 109 may configure connections with network controller 105 to service stream 123 or network function 124. Messaging/streaming engine 109 may configure connections with resource orchestrator 102 to cloud infrastructure stream 125.

At step 133, connecting messaging/streaming engine 109 with the multiple external system functions, such as a user interface 106, service orchestrator 104, inventory 103, network controller 105, or resource orchestrator 102, as configured. The multiple functions may have steps that are executed asynchronously.

At step 134, executing the implementation of services using the messaging/streaming engine 109. In an example, service orchestrator 123 may connect to use network function 124, but responses may be handled by service response stream 121.

The disclosed subject matter may be specific to telecommunications network and focused on OSS/BSS applications and inventory systems. Asynchronous operations may eliminate timeout and latency issues which may provide more efficient use of resources; simplify onboarding of applications (e.g., interact w/ DMaaP topics); or broker functions that may be used to consolidate (e.g., stack) multiple streams eliminating rigid sequenced process.

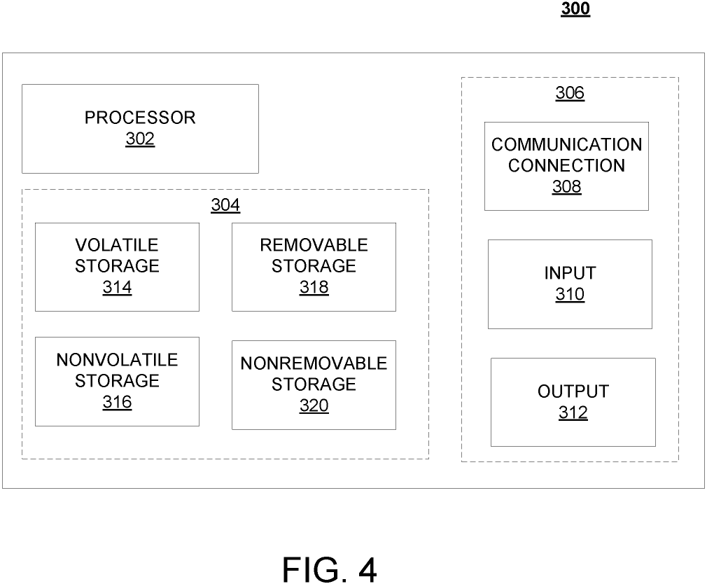

FIG. 4 is a block diagram of network device 300 that may be connected to or comprise a component of FIG. 1 or FIG. 2. Network device 300 may comprise hardware or a combination of hardware and software. The functionality to facilitate telecommunications via a telecommunications network may reside in one or combination of network devices 300. Network device 300 depicted in FIG. 4 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 4 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 4) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

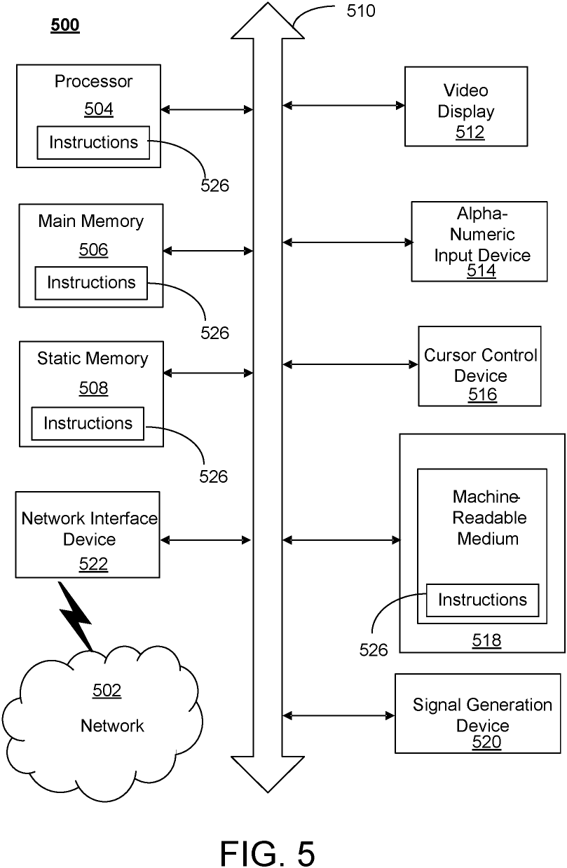

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 302, network device 101, resource orchestrator 102, network controller 105, user interface 106, and other devices of FIG. 1 and FIG. 2. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life-especially for simple M2M devices-through enhanced wireless management.

While examples of a system in which asynchronous network system alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure — asynchronous network system — as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for creating a streaming engine, the streaming engine comprises a plurality of streaming functions; configuring the plurality of streaming functions to connect with a plurality of external system functions; connecting the streaming engine with the plurality of external system functions; and executing services using the streaming engine, wherein the multiple external system functions operate asynchronously with the streaming engine. The plurality of streaming functions may include a service request stream, a service stream, a network function stream, or cloud infrastructure stream. The plurality of external system functions may include user interface, service orchestrator, inventory, network controller, or resource orchestrator. All combinations in this paragraph (including the removal or addition of steps) are contemplated in a manner that is consistent with the other portions of the detailed description.

1. A method comprising:
creating a streaming engine, the streaming engine comprises a plurality of streaming functions;
configuring the plurality of streaming functions to connect with a plurality of external system functions;
connecting the streaming engine with the plurality of external system functions; and
executing services using the streaming engine, wherein the plurality of external system functions operate asynchronously with the streaming engine, and wherein the executing of the services is based on a sequence of event messages with time stamps that create an event flow in an order in the streaming engine, the event messages pertaining to provisioning, changed statuses, updated services, or any combination thereof,
wherein the plurality of external system functions comprises a user interface, a service orchestrator, an inventory, a network controller, and a resource orchestrator,
wherein the inventory receives a first message to engage a first lookup of inventory for display on the user interface,
wherein, based on input from the user interface and based on the first message, a request is initiated and sent to the service orchestrator,
wherein the service orchestrator sends a second message to the network controller to activate network service based on the request,
wherein the inventory receives a second lookup of inventory from the network controller based on the second message, and
wherein the network controller sends instructions to configure a network device based on the second lookup.

2. The method of claim 1, wherein the plurality of streaming functions comprises a service response stream.

3. The method of claim 1, wherein the plurality of streaming functions comprises a service request stream.

4. The method of claim 1, wherein the plurality of streaming functions comprises a service stream.

5. The method of claim 1, wherein the plurality of streaming functions comprises a network function stream.

6. The method of claim 1, wherein the plurality of streaming functions comprises a cloud infrastructure stream.

7. (canceled)

8. An apparatus comprising:
a processor; and
a memory coupled with the processor, the memory storing executable instructions that when executed by the processor cause the processor to effectuate operations comprising:
creating a streaming engine, the streaming engine comprises a plurality of streaming functions;
configuring the plurality of streaming functions;
connecting, based on the configuring, the streaming engine with a plurality of external system functions; and
executing services using the streaming engine, wherein the plurality of external system functions operate asynchronously with the streaming engine, and wherein the executing of the services is based on a sequence of event messages with time stamps, the event messages pertaining to provisioning, changed statuses, updated services, or any combination thereof,
wherein the plurality of external system functions comprises a user interface, a service orchestrator, an inventory, a network controller, and a resource orchestrator,
wherein the inventory receives a first message to engage a first lookup of inventory for display on the user interface,
wherein, based on input from the user interface and based on the first message, a request is initiated and sent to the service orchestrator,
wherein the service orchestrator sends a second message to the network controller to activate network service based on the request,
wherein the inventory receives a second lookup of inventory from the network controller based on the second message, and
wherein the network controller sends instructions to configure a network device based on the second lookup.

9. The apparatus of claim 8, wherein the plurality of streaming functions comprises a service response stream.

10. The apparatus of claim 8, wherein the plurality of streaming functions comprises a service request stream.

11. The apparatus of claim 8, wherein the plurality of streaming functions comprises a service stream.

12. The apparatus of claim 8, wherein the plurality of streaming functions comprises a network function stream.

13. The apparatus of claim 8, wherein the plurality of streaming functions comprises a cloud infrastructure stream.

14. (canceled)

15. A tangible computer readable storage medium storing computer executable instructions that when executed by a computing device cause said computing device to effectuate operations comprising:
creating a streaming engine, the streaming engine comprises a plurality of streaming functions;
configuring the plurality of streaming functions to connect with a plurality of external system functions; and
executing services based on a connection between the streaming engine and the plurality of external system functions in accordance with the configuring, wherein the plurality of external system functions operate asynchronously with the streaming engine, and wherein the executing of the services is based on a sequence of event messages with time stamps, the event messages pertaining to provisioning, changed statuses, updated services, or any combination thereof,
wherein the plurality of external system functions comprises a user interface, a service orchestrator, an inventory, a network controller, and a resource orchestrator,
wherein the inventory receives a first message to engage a first lookup of inventory for display on the user interface,
wherein, based on input from the user interface and based on the first message, a request is initiated and sent to the service orchestrator,
wherein the service orchestrator sends a second message to the network controller to activate network service based on the request,
wherein the inventory receives a second lookup of inventory from the network controller based on the second message, and
wherein the network controller sends first instructions to configure a network device based on the second lookup.

16. The tangible computer readable storage medium of claim 15, wherein the plurality of streaming functions comprises a service request stream and a service response stream.

17. (canceled)

18. The tangible computer readable storage medium of claim 15, wherein the plurality of streaming functions comprises a service stream and a network function stream.

19. (canceled)

20. (canceled)

21. (canceled)

22. The tangible computer readable storage medium of claim 15, wherein the resource orchestrator pushes cloud infrastructure of the inventory asynchronously, wherein the user interface creates service requests asynchronously, wherein the service orchestrator pulls the service requests asynchronously, and wherein the network controller performs an activation and configuration of network functions asynchronously.

23. The tangible computer readable storage medium of claim 15, wherein the network device comprises a device of a cellular broadcast system.

24. The tangible computer readable storage medium of claim 15, wherein the network controller sends second instructions to create a network function inventory based on the first instructions that configure the network device.

25. The tangible computer readable storage medium of claim 15, wherein the operations further comprise:
archiving streams of the services in an inventory database for analytics and reporting via a display of the user interface.

26. The tangible computer readable storage medium of claim 15, wherein the inventory comprises a physical network element, a virtual network element, a virtual network function, a specification of a first relationship between the physical network element and the virtual network element, a specification of a second relationship between the physical network element and the virtual network function, and a specification of a third relationship between the virtual network element and the virtual network function.
